(19) United States
(12) Patent Application Publication
(10) Pub. No.: US 2024/0288297 A1
(43) Pub. Date: Aug. 29, 2024

(54) SENSOR DEVICE FOR CAPTURING SENSOR INFORMATION DESCRIBING THE FILL LEVEL OF A MEDIUM IN A CONTAINER

(71) Applicant: BEDIA Motorentechnik GmbH & Co. KG, Altdorf (DE)

(72) Inventors: Gernot KETTLER, Altdorf (DE); Daniel SCHMIDT, Altdorf (DE)

(21) Appl. No.: 18/576,702

(22) PCT Filed: Jul. 1, 2022
(86) PCT No.: PCT/EP2022/068310

§ 371 Date: Jan. 4, 2024

(30) Foreign Application Priority Data
Jul. 5, 2021 (DE) 10 2021 117 316.7

(51) Int. Cl. G01F 23/00

(52) U.S. Cl. CPC G01F 23/00

(57) ABSTRACT

A sensor device for acquiring filling level information describing the filling level of a medium in a container includes a housing means and a sensor means for acquiring filling level information describing the filling level of a medium in a container, wherein the housing means includes a fastening region for fastening the sensor means, which region includes a first fastening portion for forming a threaded connection with a corresponding first fastening portion of the sensor means, and a second fastening portion separate from the first fastening portion for forming a press-fit connection, in particular a cone press-fit connection, with a corresponding second fastening portion of the sensor means; and/or the sensor means includes a fastening region for fastening the housing means, which region comprises a first fastening portion for forming a threaded connection with a corresponding first fastening portion of the housing means, and a second fastening portion separate from the first fastening portion for forming a press-fit connection, in particular a cone press-fit connection, with a corresponding second fastening portion of the housing means.

The invention relates to a sensor device for acquiring sensor information describing the filling level of a medium in a container, comprising a housing means and a sensor means which can be or is fastened to the housing means and is intended for acquiring sensor information describing the filling level of a medium in a container.

Corresponding sensor devices for acquiring sensor information describing the filling level of a medium in a container are known in principle from the prior art in a plurality of different embodiments.

The basic configuration of corresponding sensor devices typically comprises a housing means and a, for example special type or form of, sensor means which can be or is fastened to the housing means and is intended for acquiring sensor information describing the filling level of a medium in a container.

The length dimensions of corresponding sensor means can sometimes be considerable, in order to ensure a reliable acquisition of corresponding filling level information even in large and correspondingly deep containers. Specifically, corresponding sensor means can therefore for example be of a length of 15 cm or more.

However, the length dimensions of corresponding sensor means are a challenge for the stability of the fastening of respective sensor means on respective housing means, since significant forces or torques can act on the sensor means. This applies in particular against the background of possible spatially limited available cross sections.

Known fastening principles require improvement or development here, since these typically provide only simple screwing of corresponding housing means and sensor means.

The object of the invention is therefore that of specifying a sensor device for acquiring sensor information describing the filling level of a medium in a container which is improved in particular in view of a stable fastening of the housing means and the sensor means.

The object is achieved by a sensor device for acquiring sensor information describing the filling level of a medium in a container, according to claim 1. The claims dependent thereon relate to possible embodiments of the sensor device.

A first aspect of the invention relates to a sensor device for acquiring sensor information describing the filling level of a medium, such as a gas and/or a solid and/or a liquid, in a container, such as a tank. The sensor device is accordingly designed in particular for acquiring sensor information describing the filling level of a medium in a container. Corresponding sensor information can be or include for example sensor signals, from which filling level information describing a filling level of a respective medium in a respective container can be determined by corresponding evaluation. In principle, it is also conceivable that the sensor device is designed for acquiring chemical and/or physical parameters, e.g. electrical parameters, i.e. for example the electrical conductivity, of a medium in a container.

The sensor device comprises a housing means and a sensor means which can be or is fastened to the housing means. The sensor means, e.g. formed as a special type or form, is designed for acquiring sensor information describing the filling level of a medium in a container. For this purpose, the sensor means typically comprises at least one active or passive sensor element which is designed to acquire corresponding sensor information.

Corresponding sensor information is typically transmitted to an evaluation means, implemented by hardware and/or software, via suitable connection elements, such as signal lines. A corresponding evaluation means can be designed to evaluate corresponding sensor information in view of the or a filling level, to be determined, of a respective medium in a respective container. A corresponding evaluation means can constitute a component of a device at a higher level than the sensor device, for determining the filling level of a fluid in a container.

Both corresponding connection elements and a corresponding evaluation means can be arranged or formed at least in portions, optionally completely, on or in the housing means. For this purpose, the housing means can be formed having a receiving space, optionally of a drilled hole type, or can comprise such a space.

As emerges in the following, the housing means and the sensor means are configured in a particular manner, in view of an, optionally detachable (without damage or destruction), stable possibility for fastening the sensor means to the housing means, and vice versa:

The housing means comprises a fastening region, optionally also to be referred to or considered as a fastening means, for fastening the housing means to the sensor means, and vice versa. The fastening region of the housing means is thus generally configured in such a way as to achieve mechanically extremely stable fastening of the sensor means to the housing means, and vice versa. The fastening region of the housing means can be arranged or formed on a flange-like portion of the housing means. The particular feature of the fastening region of the housing means results from the fact that said region comprises separate fastening portions, configured so as to be geometrically/structurally or functionally different. Specifically, the fastening region comprises a first fastening portion for forming a threaded connection with a corresponding first fastening portion of the sensor means, and a second fastening portion separate from the first fastening portion for forming a press-fit connection, in particular a cone press-fit connection, with a corresponding second fastening portion of the sensor means. The first fastening portion on the housing means side is thus designed to interact with a or the corresponding first fastening portion on the sensor means side, forming a threaded connection or fastening. The second fastening portion on the housing means side is thus designed to interact with a or the corresponding second fastening portion on the sensor means side, forming a press-fit connection or fastening, i.e. in particular a cone press-fit connection or fastening.

The fastening region of the housing means can be formed on a main body of the housing means. The housing means can accordingly be formed by a, for example metal, main body, or can comprise such a body. The main body can have a cylinder-like or cylindrical, i.e. in particular a hollow cylinder-like or hollow cylindrical, basic shape. In particular, the fastening region of the housing means can have a cylinder-like or cylindrical, i.e. in particular a hollow cylinder-like or hollow cylindrical, basic shape. The basic shape of the housing means can optionally also be referred to as or considered to be the housing body.

The sensor means comprises a fastening region, optionally also to be referred to or considered as a fastening means, for fastening the sensor means to the housing means, and vice versa. The fastening region of the sensor means is thus generally configured in such a way as to achieve mechanically extremely stable fastening of the sensor means to the housing means, and vice versa. The fastening region of the sensor means can be arranged or formed on a flange-like portion of the sensor means. The particular feature of the fastening region of the sensor means results—analogously to the fastening region of the housing means—from the fact that said region comprises separate fastening portions, configured so as to be geometrically/structurally or functionally different. Specifically, the fastening region comprises a first fastening portion for forming a threaded connection with a corresponding first fastening portion of the housing means, and a second fastening portion separate from the first fastening portion for forming a press-fit connection, in particular a cone press-fit connection, with a corresponding second fastening portion of the housing means. The first fastening portion on the sensor means side is thus designed to interact with a or the corresponding first fastening portion on the housing means side, forming a threaded connection or fastening.

The second fastening portion on the sensor means side is thus designed to interact with a or the corresponding second fastening portion on the housing means side, forming a press-fit connection or fastening, i.e. in particular a cone press-fit connection or fastening.

The fastening region of the sensor means can be formed on a main body of the sensor means. The sensor means can accordingly be formed by a, for example metal or ceramic, main body, or can comprise such a body. The main body can have a cylinder-like or cylindrical basic shape. In particular, the fastening region of the sensor means can have a cylinder-like or cylindrical basic shape. The main body of the sensor means can optionally also be referred to as or considered to be the sensor body.

Due to the interaction of respective fastening regions on the housing means side and sensor means side, i.e. in particular respective first and second fastening portions on the housing means side and sensor means side, which interaction is possible on account of configurations that are matched to one another, a combination of a threaded and a press-fit fastening, i.e. in particular a cone press-fit fastening, and thus overall a combined fastening principle, can be achieved, which allows for a very stable fastening of the sensor means to the housing means, and vice versa, in particular compared with a simple screw fastening. On the basis of studies, it was possible to show that the stability of the fastening can be greater by a factor of two than in the case of a simple screw fastening. This can apply in particular against the background of possible spatially limited available cross sections.

This applies in particular against the background that the typically rod-like or rod-shaped sensor means can have a length-to-diameter ratio of at least 2:1, in particular at least 3:1, more particularly at least 4:1, more particularly at least 5:1, more particularly at least 6:1, more particularly at least 7:1, more particularly at least 8:1, more particularly at least 9:1, more particularly at least 10:1, more particularly at least 11:1, more particularly at least 12:1, more particularly at least 13:1, more particularly at least 14:1, more particularly at least 15:1. The length of the sensor means can thus be significantly greater than its diameter, which, as indicated at the outset, in principle makes stable fastening more difficult. Viewed in absolute terms, the sensor means can for example have a length of at least 15 cm, in particular at least 20 cm, more particularly at least 25 cm, more particularly at least 30 cm. However, the above-described fastening principle of the sensor device described herein makes it possible to achieve extremely stable fastening, even in such difficult fastening conditions.

Due to the interaction of respective fastening regions on the housing means side and sensor means side, i.e. in particular respective first and second fastening portions on the housing means side and sensor means side, which interaction is possible on account of configurations that are matched to one another, a certain variability of the stability of the fastening is also possible, since the press-fit connection resulting from the interaction of the respective second fastening portions can optionally be purposely influenced by screwing of the respective first fastening portions and the associated mutual engagement of the respective first fastening portions, as the forces acting on the respective second fastening portions, for establishing the press-fit connection, can be purposely influenced by tightening the screw fastening of the respective first fastening portions.

Overall, an improved sensor device for acquiring sensor information describing the filling level of a medium in a container is provided.

As mentioned, the housing means typically comprises a main body. The main body has a symmetry or central axis, which can be the or a longitudinal axis of the main body or of the housing means. The fastening region of the housing means can be arranged or formed in the region of a free end of the main body. This is a practical arrangement possibility in view of the fastening, which can be or is to be established, of the housing means to the sensor means, and vice versa.

In particular, the second fastening portion of the fastening region of the housing means can be arranged or formed in the region of the free end of the main body of the housing means, and the first fastening portion of the fastening region of the housing means can be arranged or formed, in relation to the free end, so as to be offset in the direction of another free end. Therefore, the second fastening portion is arranged or formed, typically directly, on the free end of the main body. Thus, the second fastening portion typically forms the free end of the main body of the housing means, which faces the sensor means in the mounted state of the sensor device.

As also mentioned, the sensor means also typically comprises a main body. The main body has a symmetry or central axis, which can be the or a longitudinal axis of the main body or of the sensor means. The fastening region of the sensor means can be arranged or formed in the region of a free end of the main body. This is a practical arrangement possibility in view of the fastening, which can be or is to be established, of the sensor means to the housing means, and vice versa.

In particular, the first fastening portion of the fastening region of the sensor means can be arranged or formed in the region of the free end of the main body of the sensor means, and the second fastening portion of the fastening region of the sensor means can be arranged or formed, in relation to the free end, so as to be offset in the direction of another free end. Therefore, the first fastening portion is arranged or formed, typically directly, on the free end of the main body. Thus, the first fastening portion typically forms the free end of the main body of the sensor means, which faces the housing means in the mounted state of the sensor device.

However, it is also conceivable for the fastening region of the sensor means to be arranged or formed so as to be spaced apart from a free end of the main body of the sensor means. This applies in particular for configurations in which a free end of the sensor means protrudes or plunges further into the housing means, beyond the fastening region of the housing means, in the mounted state of the sensor device.

As mentioned, the respective first fastening portions of the fastening regions of the housing means and of the sensor means are designed for forming a threaded connection or fastening. The first fastening portion of the fastening region of the housing means can be formed by an internal thread or an internal thread portion. The first fastening portion of the fastening region of the sensor means can be formed by an, in particular corresponding, external thread or a corresponding external thread portion. The respective internal or external threads can optionally be fine-pitch threads.

As also mentioned, the respective second fastening portions of the fastening regions of the housing means and of the sensor means are designed for forming a press-fit connection or fastening, i.e. in particular a cone press-fit connection or fastening. The second fastening portion of the fastening region of the housing means can be formed by a cone surface that widens in the axial direction, with respect to the or a symmetry or central axis of the housing means, in particular the symmetry or central axis of the main body of the housing means. In a (longitudinal) sectional view of the housing means, corresponding cone surfaces of the housing means constitute sloping surfaces that widen in the axial direction with respect to the or a symmetry or central axis of the housing means, in particular the symmetry or central axis of the main body of the housing means, in the direction of the end of the housing means provided with the fastening region.

The second fastening portion of the fastening region of the sensor means can be formed by, in particular corresponding, cone surfaces that taper in the axial direction, with respect to the or a symmetry or central axis of the sensor means, in particular the symmetry or central axis of the main body of the sensor means. In a (longitudinal) sectional view of the sensor means, corresponding cone surfaces of the sensor means constitute sloping surfaces that taper in the axial direction with respect to the or a symmetry or central axis of the sensor means, in particular the symmetry or central axis of the main body of the sensor means, in the direction of the end of the sensor means provided with the fastening region.

Corresponding cone surfaces of the second fastening portions of the fastening region of the housing means and/or of the sensor means can also be referred to or considered, in all embodiments, as truncated cone surfaces.

Half the opening angle α of a cone of the housing means and/or of the sensor means defined by corresponding cone surfaces is generally in the following range: 0<α<90°. Half the opening angle of a cone of the housing means and/or of the sensor means defined by corresponding cone surfaces can thus be for example in a range between 0.1 and 90°, in particular in a range between 4 and 45°, more particularly in a range between 10 and 35°, more particularly in a range between 15 and 25°. The respective half of the opening angle of the cone surfaces on the housing means side and, on the sensor, means side are typically, but not necessarily, congruent. The mentioned angular ranges are easily presentable in terms of manufacturing technology, and allow for extremely stable fastening of the sensor means to the housing means, and vice versa.

As mentioned, the respective first and second fastening portions are to be considered as separate portions, at least from a geometric/structural perspective, of the respective fastening regions, of the housing and sensor means. The respective first and second fastening portions of a respective fastening region can thus be spatially delimited from one another. In this connection, the following embodiments are conceivable, by way of example:

The first fastening portion of the fastening region of the housing means can adjoin the second fastening portion of the fastening region of the housing means, in particular directly, in particular in the axial direction with respect to the or a symmetry or central axis of the housing means. As mentioned, the second fastening portion of the fastening region of the housing means typically forms the or a free end of the housing means. In the same way, the first fastening portion of the fastening region of the sensor means can adjoin the second fastening portion of the fastening region of the sensor means, in particular directly, in particular in the axial direction with respect to the or a symmetry or central axis of the sensor means. As mentioned, the first fastening portion of the fastening region of the sensor means typically forms the or a free end of the sensor means.

It is also conceivable for the first fastening portion of the fastening region of the housing means to adjoin the second fastening portion of the fastening region of the housing means with interposition of a third fastening portion that extends radially inwards with respect to a symmetry or central axis of the housing means. Thus, a third fastening portion can be arranged or formed between the second fastening portion, which forms the free end of the housing means, and the first fastening portion. The third fastening portion can extend inwards, in the radial direction, by a certain amount, e.g. by an amount from the range between 0.01 and 0.1 mm.

In the same way, the first fastening portion of the fastening region of the sensor means can adjoin the second fastening portion of the fastening region of the sensor means with interposition of a third fastening portion that extends radially inwards with respect to a symmetry or central axis of the sensor means. Thus, a third fastening portion can be arranged or formed between the first fastening portion, which forms the free end of the sensor means, and the second fastening portion. The third fastening portion can extend inwards, in the radial direction, by a certain amount, e.g. by an amount from the range between 0.01 and 0.1 mm.

By means of the typically corresponding third fastening portions—analogously to the respective first and second fastening portions—a loss prevention means can optionally be realized, which, for example in the context of establishing the fastening, prevents the sensor means from falling out of the housing means in an undesired manner.

As mentioned, the fastening region of the housing means can be arranged or formed on a flange-like or flange-shaped portion of the housing means. The flange-like portion can have elastic/resilient properties, for example by means of a suitable (reduction in) wall thickness. In this way, the assembly of the sensor device, which typically takes place by inserting the sensor means into the housing means and screwing the respective first fastening portions, can be simplified. The flange-like or flange-shaped portion can be formed on the side of the outer periphery, having a fastening interface for fastening the housing means, optionally together with the sensor means fastened thereon, to a corresponding fastening interface of a container. A corresponding fastening interface can for example be an external thread.

A second aspect of the invention relates to a device for determining the filling level of a medium in a container The device can in particular be designed to determine the filling level of, e.g. oily or aqueous, fluids, such as operating fluids, of a vehicle, in particular of a motor vehicle, or of a work machine, in particular a construction or agricultural machine.

The device comprises a sensor device according to a first aspect of the invention and an evaluation means which communicates with the sensor device and is implemented by means of hardware and/or software, and which is designed for evaluating sensor information that can be or is delivered by the sensor means for generating filling level information that describes a current or future filling level of a medium in the respective container. The evaluation means can be designed to generate corresponding filling level information on the basis of measuring principles that are known per se, such as capacitive measuring principles. Alternatively or in addition, the evaluation means for evaluating sensor information that can be or is delivered by the sensor means can be designed for generating parameter information that describes a chemical and/or physical parameter of a medium in the respective container.

The evaluation means can furthermore be designed to generate evaluation information that describes an evaluation result, and to output said information, via a suitable output means, such as a display means and/or a wired or wireless communication means, to a user and/or to a terminal on the user side. The device can thus optionally also comprise a corresponding evaluation means and/or output means.

A third aspect of the invention relates to the use of a device according to the second aspect of the invention for determining the filling level of a medium in a container The use of the device or likewise makes it possible for a method for determining the filling level of a medium in a container to be implemented. The use of the device or the method can also constitute a stand-alone aspect of the invention.

All the embodiments in connection with the sensor device according to the first aspect of the invention apply analogously for the device according to the second aspect of the invention and/or for the use or the method according to the third aspect of the invention.

The invention is explained again, by way of example, with reference to embodiments in the drawings, in which:

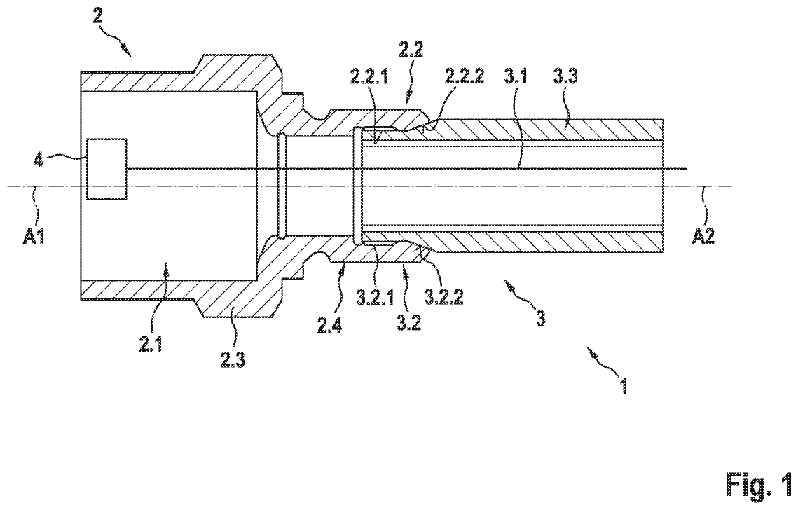

FIG. 1, 2 are each schematic views of a sensor device according to an embodiment.

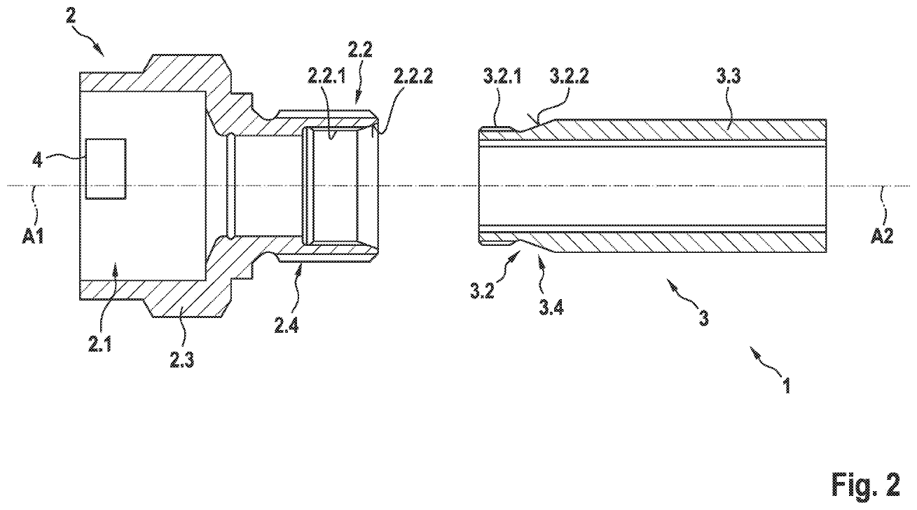

FIGS. 1 and 2 are each schematic longitudinal sectional views of a sensor device 1 or its components according to an embodiment. Specifically, in each case a detail of the sensor device 1 is shown, which is relevant to the explanation of the principle described herein.

The sensor device 1 is designed for acquiring sensor information describing the filling level of a medium, such as a gas and/or a solid and/or a liquid, in a container (not shown), such as a tank. Corresponding sensor information can be or include for example sensor signals, from which filling level information describing a filling level of a respective medium in a respective container can be determined by corresponding evaluation.

The sensor device 1 comprises a housing means 2 and a sensor means 3 which can be or is fastened to the housing means 2. The sensor means 3, formed by way of example in the drawings as a special type or form, is designed for acquiring sensor information describing the filling level of a medium in a container. For this purpose, the sensor means 3 comprises at least one sensor element 3.1 (indicated purely schematically), which is designed to acquire corresponding sensor information.

Corresponding sensor information is typically transmitted to an evaluation means 4, implemented by hardware and/or software, via suitable connection elements (not shown), such as signal lines. A corresponding evaluation means 4 can be designed to evaluate corresponding sensor information in view of the or a filling level, to be determined, of a respective medium in a respective container. A corresponding evaluation means 4 can, as shown purely by way of example in FIG. 1, be arranged or formed in a receiving space 2.1 of the housing means 2. It is also conceivable for the or a corresponding evaluation means 4 to form a component of a device at a higher level than the sensor device 1, for determining the filling level of a fluid in a container.

Corresponding connection elements as well as (cf. FIG. 1) a corresponding evaluation means 4 can be arranged or formed on or in the housing means 2. For this purpose, the housing means comprises the above-mentioned receiving space 2.1, which can be formed for example in the manner or form of a drilled hole.

The housing means 2 and the sensor means 3 are configured in a particular manner, in view of an, optionally detachable (without damage or destruction), stable possibility for fastening the sensor means 3 to the housing means 2, and vice versa:

The housing means 2 comprises a fastening region 2.2, optionally also to be referred to or considered as a fastening means, for fastening the housing means 2 to the sensor means 3, and vice versa. The fastening region 2.2 is generally configured in such a way as to achieve mechanically extremely stable fastening of the sensor means 3 to the housing means 2, and vice versa. The fastening region 2.2 can be arranged or formed on a flange-like portion 2.4 of the housing means. The particular feature of the fastening region 2.2 results from the fact that said region comprises separate fastening portions 2.2.1, 2.2.2, configured so as to be geometrically/structurally or functionally different. Specifically, the fastening region 2.2 comprises a first fastening portion 2.2.1 for forming a threaded connection with a corresponding first fastening portion 3.2.1 of the sensor means 3, and a second fastening portion 2.2.2 separate from the first fastening portion 2.2.1 for forming a press-fit connection, in particular a cone press-fit connection, with a corresponding second fastening portion 3.2.2 of the sensor means 3. The first fastening portion 2.2.1 on the housing means side is thus designed to interact with a or the corresponding first fastening portion 3.2.2 on the sensor means side, forming a threaded connection or fastening. The second fastening portion 2.2.2 on the housing means side is thus designed to interact with a or the corresponding second fastening portion 3.2.2 on the sensor means side, forming a press-fit connection or fastening, i.e. in particular a cone press-fit connection or fastening.

It can be seen that the fastening region 2.2 of the housing means 2 is formed on a main body 2.3 of the housing means 2, optionally also to be referred to as the housing body. The housing means 2 is accordingly formed by a, for example metal, main body 2.3, or comprises such a body. In the embodiment, the main body 2.3 has a hollow cylinder-like or hollow cylindrical basic shape. In particular, the fastening region 2.2 of the housing means 2 has a hollow cylinder-like or hollow cylindrical basic shape.

The sensor means 3 comprises a fastening region 3.2, optionally also to be referred to or considered as a fastening means, for fastening the sensor means 3 to the housing means 2, and vice versa. The fastening region 3.2 is generally configured in such a way as to achieve mechanically extremely stable fastening of the sensor means 3 to the housing means 2, and vice versa. The fastening region 3.2 can be arranged or formed on a flange-like portion 3.4 of the sensor means 3. The particular feature of the fastening region 3.2 results, analogously to the fastening region 2.2 of the housing means 2, from the fact that said region comprises separate fastening portions 3.2.1, 3.2.2, configured so as to be geometrically/structurally or functionally different. Specifically, the fastening region 3.2 comprises a first fastening portion 3.2.1 for forming a threaded connection with a corresponding first fastening portion 2.2.1 of the housing means 2, and a second fastening portion 3.2.2 separate from the first fastening portion 3.2.1 for forming a press-fit connection, in particular a cone press-fit connection, with a corresponding second fastening portion 2.2.2 of the housing means 2. The first fastening portion 3.2.1 on the sensor means side is thus designed to interact with a or the corresponding first fastening portion 2.2.1 on the housing means side, forming a threaded connection or fastening. The second fastening portion 3.2.2 on the sensor means side is thus designed to interact with a or the corresponding second fastening portion 2.2.2 on the housing means side, forming a press-fit connection or fastening, i.e. in particular a cone press-fit connection or fastening.

The fastening region 3.2 of the sensor means 3 is formed on a main body 3.3 of the sensor means 3, optionally also to be referred to as the sensor body. The sensor means 3 is accordingly formed by a, for example metal or ceramic, main body 3.3, or comprises such a body. The main body 3.3 has a cylinder-like or cylindrical basic shape. In particular, the fastening region 3.2 of the sensor means 3 has a cylinder-like or cylindrical basic shape.

Due to the interaction of respective fastening regions 2.2, 3.2 on the housing means side and sensor means side, i.e. in particular respective first and second fastening portions 2.2.1, 2.2.2, 3.2.1 3.2.2 on the housing means side and sensor means side, which interaction is possible on account of configurations that are matched to one another, a combination of a threaded and a press-fit fastening, i.e. in particular a cone press-fit fastening, and thus overall a combined fastening principle, can be achieved, which allows for a very stable fastening of the sensor means 3 to the housing means 2, and vice versa, in particular compared with a simple screw fastening.

This applies in particular against the background that the rod-like or rod-shaped sensor means 3 typically has a length-to-diameter ratio of at least 2:1, in particular at least 3:1, more particularly at least 4:1, more particularly at least 5:1, more particularly at least 6:1, more particularly at least 7:1, more particularly at least 8:1, more particularly at least 9:1, more particularly at least 10:1, more particularly at least 11:1, more particularly at least 12:1, more particularly at least 13:1, more particularly at least 14:1, more particularly at least 15:1. The length of the sensor means 3 can thus be significantly greater than its diameter or cross section, which, as indicated at the outset, in principle makes stable fastening more difficult. However, the above-described fastening principle of the sensor device 1 makes it possible to achieve extremely stable fastening, even in such difficult fastening conditions.

Due to the interaction of respective fastening regions 2.2, 3.2 on the housing means side and sensor means side, i.e. in particular respective first and second fastening portions 2.2.1, 2.2.2, 3.2.1 3.2.2 on the housing means side and sensor means side, which interaction is possible on account of configurations that are matched to one another, a certain variability of the stability of the fastening is also possible, since the press-fit connection resulting from the interaction of the respective second fastening portions 2.2.2, 3.2.2 can optionally be purposely influenced by screwing of the respective first fastening portions 2.2.1, 3.2.1 and the associated mutual engagement of the respective first fastening portions, as the forces acting on the respective second fastening portions 2.2.2, 3.2.2, for establishing the press-fit connection, can be purposely influenced by tightening the screw fastening of the respective first fastening portions 2.2.1, 3.2.1.

It can be seen that the main body 2.3 of the housing means 2 has a symmetry or central axis A1, which can be the or a longitudinal axis of the main body 2.3 or of the housing means 2. In the embodiment, the fastening region 2.2 of the housing means 2 is arranged or formed in the region of the free end of the main body 2.3 facing the sensor means 3.

It can be seen that the second fastening portion 2.2.2 of the fastening region 2.2 of the housing means 2 is arranged or formed in the region of the free end of the main body 2.3 of the housing means 2 facing the sensor means 3, and the first fastening portion 2.2.1 of the fastening region 2.2 of the housing means 2 is arranged or formed, in relation to the free end, so as to be offset in the direction of another free end. Therefore, in the embodiment, the second fastening portion 2.2.2 is arranged or formed directly on the free end of the main body 2.3 facing the sensor means 3; the second fastening portion 2.2.2 thus forms the free end of the main body 2.3 of the housing means 2 facing the sensor means 3.

The main body 3.3 of the sensor means 3 also has a symmetry or central axis A2, which can be the or a longitudinal axis of the main body or of the sensor means 3. In the embodiment, the fastening region 3.2 of the sensor means 3 is arranged or formed in the region of the free end of the main body 3.3 facing the housing means 2.

It can be seen that the first fastening portion 3.2.1 of the fastening region 3.2 of the sensor means 3 is arranged or formed in the region of the free end of the main body 3.3 of the sensor means 3 facing the housing means 2, and the second fastening portion 3.2.2 of the fastening region 3.2 of the sensor means 3 is arranged or formed, in relation to the free end, so as to be offset in the direction of another free end. Therefore, in the embodiment, the first fastening portion is arranged or formed directly on the free end of the main body 3.3 facing the housing means 2; the first fastening portion thus forms the free end of the main body 3.3 of the sensor means 3 facing the housing means 2.

Even if this is not shown in the drawings, it is also conceivable, however, for the fastening region 3.2 of the sensor means 3 to be arranged or formed so as to be spaced apart from the free end of the main body 3.3. This applies in particular for configurations in which a free end of the sensor means 3 protrudes or plunges further into the housing means 2, beyond the fastening region 2.2 of the housing means 2, in the mounted state of the sensor device 1.

As mentioned, the respective first fastening portions 2.2.1, 3.2.1 of the fastening regions 2.2, 3.2 of the housing means 2 and of the sensor means 3 are designed for forming a threaded connection or fastening. In the embodiment, the first fastening portion 2.2.1 of the fastening region 2.2 of the housing means 2 is formed by an internal thread or an internal thread portion. In the embodiment, the first fastening portion 3.2.1 of the fastening region 3.2 of the sensor means 3 is formed by a corresponding external thread or a corresponding external thread portion. The respective internal or external threads can optionally be fine-pitch threads.

As also mentioned, the respective second fastening portions 2.2.2, 3.2.2 of the fastening regions 2.2, 3.2 of the housing means 2 and of the sensor means 3 are designed for forming a press-fit connection or fastening, i.e. in particular a cone press-fit connection or fastening. In the embodiment, the second fastening portion 2.2.2 of the fastening region 2.2 of the housing means 2 is formed by a cone surface that widens in the axial direction, with respect to the symmetry or central axis A1 of the housing means 2 or of the main body 2.3. It can be seen that, in the (longitudinal) sectional views according to the figures, the cone surfaces constitute sloping surfaces that widen in the axial direction with respect to the symmetry or central axis A1, in the direction of the free end of the housing means 2 provided with the fastening region 2.2. In the embodiment, the second fastening portion 3.2.2 of the fastening region 3.2 of the sensor means 3 is formed by a corresponding cone surface that tapers in the axial direction, with respect to the symmetry or central axis A2 of the sensor means 3 or of the main body 3.3. It can be seen that, in the (longitudinal) sectional views according to the figures, the cone surfaces constitute sloping surfaces that taper in the axial direction with respect to the symmetry or central axis A2, in the direction of the free end of the sensor means 3 provided with the fastening region 3.2.

The respective cone surfaces of the second fastening portions 2.2.2, 3.2.2 of the housing means 2 and/or of the sensor means 3 can also be referred to or considered as truncated cone surfaces.

Half the opening angle of a cone of the housing means 2 and/or of the sensor means 3 defined by corresponding cone surfaces can generally be in a range between 0.1 and 90°. Specifically, half the opening angle of a cone of the housing means 2 and/or of the sensor means 3 defined by corresponding cone surfaces can be for example in a range between 5 and 45°, in particular in a range between 10 and 35°, more particularly in a range between 15 and 25°. As shown by way of example in the figures, the respective half of the opening angle of the cone surfaces on the housing means side and, on the sensor, means side are typically congruent.

As mentioned, the respective first and second fastening portions 2.2.1, 2.2.2, 3.2.1, 3.2.2 are to be considered as separate portions, at least from a geometric/structural perspective, of the respective fastening regions 2.2, 3.2 of the housing and sensor means 2, 3. The respective first and second fastening portions 2.2.1, 2.2.2, 3.2.1, 3.2.2 of a respective fastening region 2.2, 3.2 can thus be spatially delimited from one another. In this connection, the following embodiments are conceivable, by way of example:

The first fastening portion 2.2.1 of the fastening region 2.2 of the housing means 2 can adjoin the second fastening portion 2.2.2 of the fastening region 2.2 of the housing means 2, in particular directly, in the axial direction with respect to the symmetry or central axis A1 of the housing means 2. As mentioned, the second fastening portion 2.2.2 forms the free end of the housing means 2 facing the sensor means 3. In the same way, the first fastening portion 3.2.1 of the fastening region 3.2 of the sensor means 3 adjoins the second fastening portion 3.2.2 of the fastening region 3.2 of the sensor means 3, in particular directly, in the axial direction with respect to the symmetry or central axis A2 of the sensor means 3. As mentioned, the first fastening portion 3.2.1 of the fastening region 3.2 of the sensor means 3 forms the free end of the sensor means 3 facing the housing means 2.

It is also conceivable for the first fastening portion 2.2.1 of the fastening region 2.2 of the housing means 2 to adjoin the second fastening portion 2.2.2 with interposition of a third fastening portion (not shown) that extends radially inwards with respect to a symmetry or central axis A1 of the housing means 2. Thus, a third fastening portion can be arranged or formed between the second fastening portion 2.2.2, which forms the free end of the housing means 2, and the first fastening portion 2.2.1. The third fastening portion can extend inwards, in the radial direction, by a certain amount, e.g. by an amount from the range between 0.01 and 0.1 mm.

In the same way, the first fastening portion 3.2.1 of the fastening region 3.2 of the sensor means 3 could adjoin the second fastening portion 3.2.2 with interposition of a third fastening portion 3.2.3 that extends radially inwards with respect to the symmetry or central axis A2 of the sensor means 3. Thus, a third fastening portion (not shown) can be arranged or formed between the first fastening portion 3.2.1, which forms the free end of the sensor means 3, and the second fastening portion 3.2.2. The third fastening portion can extend inwards, in the radial direction, by a certain amount, e.g. by an amount from the range between 0.01 and 0.1 mm.

By means of the typically corresponding third fastening portions—analogously to the respective first and second fastening portions 2.2.1, 2.2.2, 3.2.1, 3.2.2—a loss prevention means can optionally be realized, which, for example in the context of establishing the fastening, prevents the sensor means 3 from falling out of the housing means 2 in an undesired manner.

The flange-like or flange-shaped portion 2.4 of the main body 2.3 of the housing means 2 can have elastic/resilient properties, for example by means of a suitable (reduction in) wall thickness. In this way, the assembly of the sensor device 1, which typically takes place by inserting the sensor means 3 into the housing means 2 and screwing the respective first fastening portions 2.2.1, 3.2.1, can be simplified. The flange-like or flange-shaped portion of the main body 2.3 of the housing means 2 can furthermore be formed on the side of the outer periphery, having a fastening interface (not denoted in more detail) for fastening the housing means 2, optionally together with the sensor means 3 fastened thereon, to a corresponding fastening interface of a container. A corresponding fastening interface can for example be an external thread.

The use of the sensor device 1 or a device comprising the sensor device 1, for determining the filling level of a medium in a container makes it possible for a method for determining the filling level of a medium in a container to be implemented.

1. Sensor device for acquiring filling level information describing the filling level of a medium in a container, comprising:
a housing means and a sensor means that can be or is fastened to the housing means and is intended for acquiring filling level information describing the filling level of a medium in a container, wherein:
the housing means comprises a fastening region for fastening the sensor means, which region comprises a first fastening portion for forming a threaded connection with a corresponding first fastening portion of the sensor means, and a second fastening portion separate from the first fastening portion for forming a press-fit connection, in particular a cone press-fit connection, with a corresponding second fastening portion of the sensor means; and/or
the sensor means comprises a fastening region for fastening the housing means, which region comprises a first fastening portion for forming a threaded connection with a corresponding first fastening portion of the housing means, and a second fastening portion separate from the first fastening portion for forming a press-fit connection, in particular a cone press-fit connection, with a corresponding second fastening portion of the housing means.

2. Sensor device according to claim 1, wherein the housing means comprises a main body having a symmetry or central axis, wherein the fastening region is arranged or formed in the region of a free end of the main body; and/or
the sensor means comprises a main body having a symmetry or central axis, wherein the fastening region is arranged or formed in the region of a free end of the main body.

3. Sensor device according to claim 2, wherein the first fastening portion of the fastening region of the housing means is arranged or formed in the region of the free end of the main body of the housing means, and the second fastening portion of the fastening region of the housing means is arranged or formed, in relation to the free end, so as to be offset in the direction of another free end, and/or
the second fastening portion of the fastening region of the sensor means is arranged or formed in the region of the free end of the main body of the sensor means, and the first fastening portion of the fastening region of the sensor means is arranged or formed, in relation to the free end, so as to be offset in the direction of another free end.

4. Sensor device according to claim 1, wherein the first fastening portion of the fastening region of the housing means is formed by an internal thread or an internal thread portion, and the first fastening portion of the fastening region of the sensor means is formed by an external thread or an external thread portion.

5. Sensor device according to claim 1, wherein the second fastening portion of the fastening region of the housing means is formed by a cone surface that widens in the axial direction, with respect to a symmetry or central axis of the housing means, and the second fastening portion of the fastening region of the sensor means is formed by a cone surface that tapers in the axial direction, with respect to a symmetry or central axis of the sensor means.

6. Sensor device according to claim 6, wherein half the opening angle of a cone of the housing means and/or of the sensor means defined by cone surfaces is in a range between 0.1 and 90°, in particular in a range between 5 and 45°, in particular in a range between 10 and 35°.

7. Sensor device according to claim 1, wherein the first fastening portion of the fastening region of the housing means adjoins the second fastening portion of the fastening region of the housing means, in particular directly, in particular in the axial direction with respect to a symmetry or central axis of the housing means, and/or
the first fastening portion of the fastening region of the sensor means adjoins the second fastening portion of the fastening region of the sensor means, in particular directly, in particular in the axial direction with respect to a symmetry or central axis of the sensor means.

8. Sensor device according to claim 1, wherein the first fastening portion of the fastening region of the housing means adjoins the second fastening portion of the fastening region of the housing means with interposition of a third fastening portion that extends radially inwards with respect to a symmetry or central axis of the housing means, and/or
the first fastening portion of the fastening region of the sensor means adjoins the second fastening portion of the fastening region of the sensor means with interposition of a third fastening portion that extends radially inwards with respect to a symmetry or central axis of the sensor means.

9. Sensor device according to claim 1, wherein the fastening region of the housing means is arranged or formed on a flange-like portion of the housing means, wherein the flange-like portion has elastic/resilient properties.

10. Sensor device according to claim 1, wherein the sensor means (3) has a length-to-diameter ratio of at least 2:1, in particular at least 3:1, more particularly at least 4:1, more particularly at least 5:1, more particularly at least 6:1, more particularly at least 7:1, more particularly at least 8:1, more particularly at least 9:1, more particularly at least 10:1, more particularly at least 11:1, more particularly at least 12:1, more particularly at least 13:1, more particularly at least 14:1, more particularly at least 15:1.

11. Device for determining the filling level of a medium in a container, comprising a sensor device according to claim 1 and an evaluation means which is designed for evaluating sensor information that can be or is delivered by the sensor means of the sensor device and is designed for generating filling level information that describes a current or future filling level of a medium in the respective container.
